(19) United States
(12) Patent Application Publication
(10) Pub. No.: US 2003/0052057 A1
(43) Pub. Date: Mar. 20, 2003

(54) Vertical support for stacked filter elements

(76) Inventors: Theophilus B. Terry III, Hodgenville, KY (US); Harry L. Nurse JR., Goshen, KY (US)

Correspondence Address: MIDDLETON & REUTLINGER, 2500 BROWN & WILLIAMSON TOWER, LOUISVILLE, KY, 40202

(21) Appl. No.: 09/954,374

(22) Filed: Sep. 17, 2001

(51) Int. Cl. B01D 29/05

(52) U.S. Cl. 210/541; 210/488; 210/232

(57) ABSTRACT

A vertically extending support for supporting a plurality of stacked discs includes an elongated extruded plastic pipe having a bottom end attached to a cap and a top end receiving a molded plastic coupling therein. The molded plastic coupling is provided with a threaded end for threadably connecting to a threaded portion of a handle.

### BACKGROUND OF THE INVENTION

The present invention relates to a vertically extending support device for supporting a plurality of stacked discs and more particularly to a vertically extending support device for a plurality of stacked filter discs for use in a filter housing in a waste water treatment plant.

There are a number of different filtering devices used in the separating of solid particulates from waste water in waste water treatment systems, such as, for example, septic tanks. Most of the devices for removing solid particulates from the waste water include separating means which provide for the solid materials to settle to the bottom of the tank with the effluent resulting therefrom being removed from the tank either by pumping or by gravity. Solid materials which settle to the bottom of the tank react with bacteria which results in smaller particulates which are then suspended in the waste water and pass through these particulate separating means with other effluent.

One particular useful type of a separating device for use in the removal of particulates from waste water are of stacked disc-dam filter units which are described in U.S. Pat. Nos. 3,332,552 and 4,710,295 to Robert Zabel and U.S. Pat. No. 5,593,584 to Harry Nurse. In these filter units, a filter housing is disposed within a waste water treatment tank, the filter housing having an open bottom to receive waste water and a plurality of stacked disc-dam type filter units. The upstream side of each disc-dam unit is in flow communication with upward flowing waste water and the downstream side of each dam is in flow communication with waste water discharge from the housing and, in turn, the waste water treatment tank. Spacing between the upper surface of a dam of one disc and a lower planar surface of an adjacent above disc defines a flow through slot for passing the waste water over the dam. This spacing between the upper surface of a dam and the lower surface of an adjacent vertically above disc determine the particle size of solids which will pass through the dam from the upstream to the downstream side. The filter assembly of stacked disc-dam filter units is mounted onto elongated vertically extending support rods which extend longitudinally through aligned holes provided within each of the discs. A cover is generally provided for the top of the stack of discs wherein the cover is provided with apertures aligned with the holes in the filter units to receive the rods therethrough. Nuts are provided to secure the lid or cover of the top of the stack of filter units. A handle is generally fixedly attached to the lid or cover. In order to perform maintenance or clean the filter units, the nuts for each of these supports must be removed and the top lid with the handle lifted upwardly so the stacked discs can then be removed from the filter housing.

### SUMMARY OF THE INVENTION

It is an object of the present invention to provide a vertically extending support for supporting a plurality of stacked disc-dam filter units.

It is another object of the present invention to provide a vertically extending support device which is easily assembled and disassembled.

It is a further object of the present invention to provide a vertically extending support device for stacked disc-dam filter units having a molded plastic handle which is threadably received by a molded plastic threaded coupling attached to an elongated vertically extending extruded plastic pipe.

More particularly, the present invention provides a stacked disc support device which includes an elongated extruded plastic pipe having a first end and a second opposed end. A molded plastic coupling having a threaded end and a non-threaded end connects a molded plastic handle to the elongated extruded plastic pipe, the molded plastic handle being threadably received on the threaded end on the molded plastic coupling and the non-threaded end of the molded plastic coupling being inserted into the first end of the pipe. A cap is attached to the second end of the vertically extending plastic pipe and in a use condition, a plurality of filter discs are mounted onto the elongated extruded plastic pipe between the cap and the handle.

Further objects and advantages of this invention will appear to those skilled in the art from the following description and appended claims, reference being to the accompanying drawings forming a part of the specification wherein like reference characters designate corresponding parts into several views.

### BRIEF DESCRIPTION OF THE DRAWINGS

FIG. 1 is a schematic view of a waste water treatment plant showing a filter assembly including a vertically extending support device of the present invention positioned within the waste water treatment tank.

FIG. 2 is an exploded, perspective view of one preferred support device of the present invention in supporting a stack of disc-dam filter units;

FIG. 3 is a top view of a disc-dam filter unit shown in the filter assembly of FIG. 2;

FIG. 4 is a perspective view of the filter assembly in FIG. 2 in assembled form with selected portions cut-away;

FIG. 5 is an exploded view of a vertically extending support device of the present invention with selected portions cut-away; and,

FIG. 6 is an exploded view of another preferred handle portion of the support device of the present invention with selected portions cut-away.

### DETAILED DESCRIPTION OF THE PREFERRED EMBODIMENT

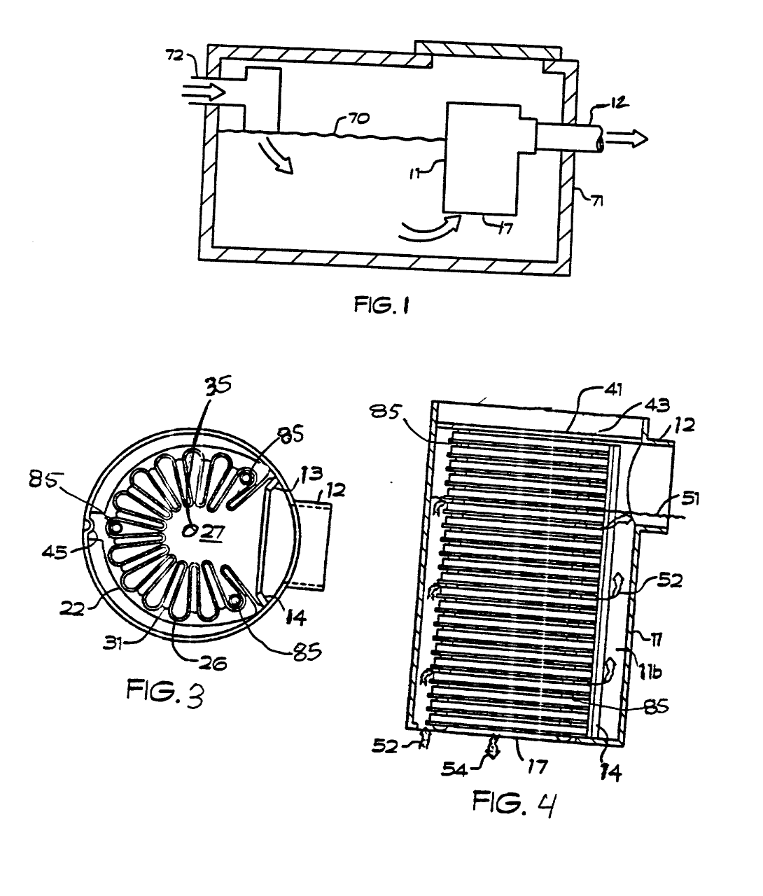

As shown in FIG. 1, a septic tank 71 includes an opening on one side thereof to receive an inlet conduit 72 for the introduction of waste water into the tank 71 and an opening in the opposite side thereof to receive a conduit 12 therethrough for the removal of filter waste water from the septic tank 71. The normal level of waste water in tank 71 is just below the inlet 72 and the outlet 12, the level of sewage in the septic tank being identified by the numeral 70. A filtering device including a filter housing 11 with a waste water inlet 17 is in flow communication on its outlet side with outlet 12.

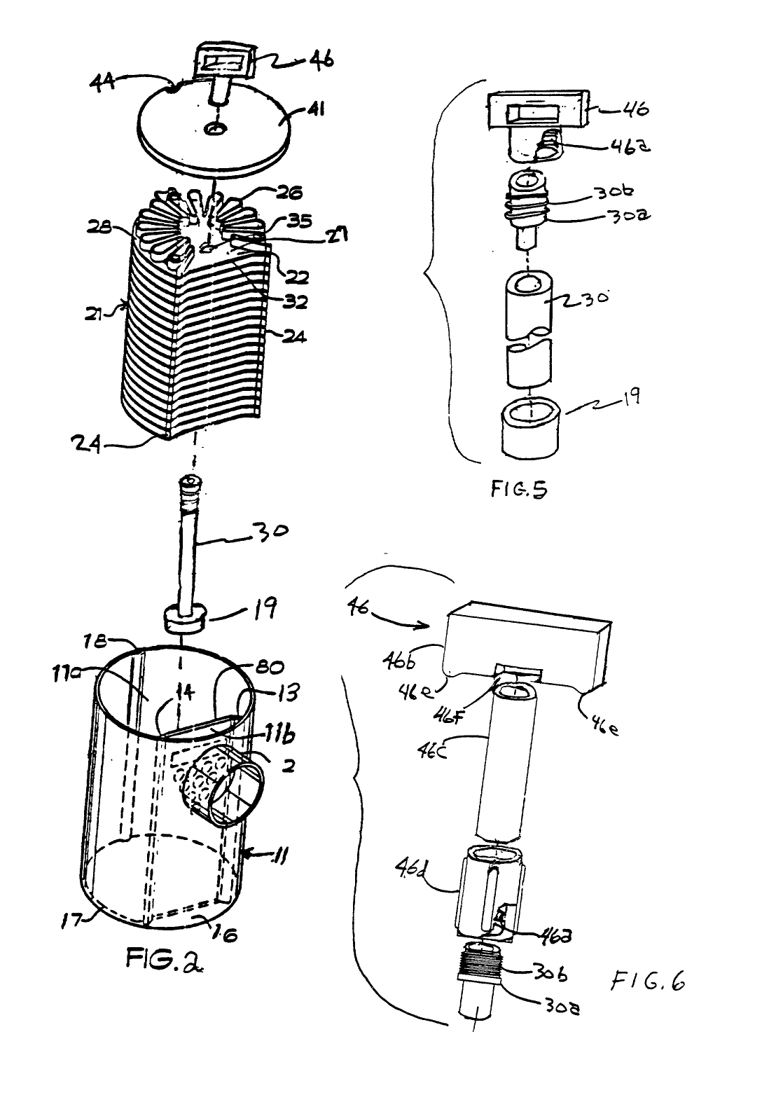

Referring now to FIG. 2, the filter housing 11 is provided with a first chamber 11a into which the waste water to be treated is received and a second chamber 11b into which the treated or filtered waste water is received. The first chamber 11a and the second chamber 11b are separated by a vertically extending partition 80. The housing 11 may be made of any suitable material, such as, for example, a plastic, including polyethylene, polypropylene, or the like.

Longitudinally extending seal members 13 and 14 are provided within housing 11 to extend generally the length of the housing, as shown, for engaging the filter units, as described hereinafter. The longitudinally extending seal members 13 and 14 may be unitary with the longitudinally extending partition 80 or may be in abutment with a movable partition 80 as shown in FIG. 2.

The housing 11 is generally cylindrical in shape and includes a lip 16 extending across a cord of the circular cross section at the bottom of housing 11 providing an opening 17 which, in operation, is located within the septic tank 71 (FIG. 1) and adapted to permit the upward flow of waste water into the housing 11. A lobe 18 is provided along one longitudinal edge of housing 11 to receive cooperating notches 45 in the filter disc 22 (Filter 3), as described hereinafter, to align the filter disc 22 within the housing 11. A filter unit 21 includes a plurality of filter discs 22 of generally circular cross-section with a cord section cut, as shown, where lips 24 are provided, also as shown, to engage seal members 13 and 14 in particular and in some cases the partition 80. The partition 80 may be, in some cases, spaced from the filter discs 22. Each of the discs 22 is provided with an elongated sinuous over-flow dam 26 which extends from one of the edges 24 to the other edge 24 in a serpentine path on top of the disc 22. There is one dam 26 on each disc 22 and the dams 26 extend vertically upward from the upper surface of the disc 22. Each disc 22 is divided into two portions. Portion 27 on one side of the dam forms an outlet while the portion 28 on the opposite side of the dam 26, forms an inlet for each of the discs 22. Moreover, spacers 85 are provided on each disc 22 to support and space adjacent above discs 22 and with the upper edge of each dam 26 define the overflow area from portion 28 to portion 27.

As shown in FIG. 3, slots 31 are provided between the turns of the dam members 26 to permit solid particulates or ash to return downwardly and out through the inlet 17 of the housing 11. Fluid flows over a dam member 26 into a chamber defined by portion 27 and the lower surface of the above discs 22 so that the clean fluid is emitted into the chamber defined by portion 27 while the particulate material, as identified by the numeral 54 (FIG. 4), falls out as the liquid passes through the spaced defined between the upper surface of the dam member 26 and the lower surface or the underside of the vertically adjacent disc 22 spaced vertically above.

As shown in FIG. 4, the level of waste water 51 is shown in the outlet 12 where a clear liquid is being emitted from the second chamber 11b, whereas the particulate material 54 is shown falling back into the septic tank through opening 17 and the particulate matter (ash) falls to the bottom of the tank for further digestion. The fluid to be treated entering the housing 11 is identified by arrow 52.

Referring again to FIG. 2, it will be seen that the entire filter assembly 21 can be mounted onto a vertically extending support rod 30 which extends longitudinally through holes 35 provided within each of the discs 22. A cover 41 can also be provided with an aperture 42 therein to receive the rod 30 therethrough. A notch 44 is provided in lid 41 and a cooperative notch 45, as shown in FIG. 3, is provided within each of the discs 22 to receive the lobe 18 as previously described. When the filtering unit 21, as shown in FIG. 2, is completely assembled with the rods 30 extending the length of the stacked discs 22 and the lid 41 is attached thereto, the entire unit 21 is located in the filter body or housing 11.

As best shown in FIG. 5, the vertically extending support 30 is an extruded plastic pipe, usually PVC, which has a first or top end and a second or bottom end wherein the second or bottom end is fixedly attached to a cap 19 on which the disc dam filter unit rests. The top end of the extruded PVC pipe 30 receives an unthreaded end of a coupling 30a which fits into the pipe and is generally affixed with any well known plastic glue for fixedly attaching the coupling to the pipe 30. The coupling 30a is a molded plastic coupling, also usually PVC, having a male threaded end 30b for receipt by the female threaded end 46a of the handle 46. Thus, in order to disassemble or assemble the stack of disc-dam filter units, merely removing the handle 46 by rotating the handle to release the threads 46a from the mating threads 46b of the elongated plastic pipe 30 allows easy access to the disc-dam units for assembling and disassembling.

In FIG. 6 is shown another handle 46 of the present invention which is made from three plastic pieces. Specifically, the handle 46 includes a hand grip portion 46b which is usually hollow with drain holes 46e on opposed ends thereof, a short piece of tube 46c, and a bushing 46d, bushing 46d having a non-threaded inner end and an opposed threaded end and an opposed threaded end with threads 46a therein for mating relation with threads 30b of coupling 30a. Tube 46c, generally an extruded PVC, connects hand grip portion 46b to the bushing 46d. Grip portion 46b is also provided with a cut-out 46f to receive one end of tube 46c and the opposed end of tube 46c is received within the non-threaded end of bushing 46d.

It is realized that various changes may be made by those skilled in the art without departing from the scope and spirit and scope of the invention as expressed in the claims appended hereto.

What is claimed is:

1. A vertically extending support device comprising:
an elongated extruded plastic pipe having a first end and an opposed second end;
a molded plastic coupling having an outer threaded end and an outer non-threaded end, said non-threaded end being inserted into said first end of said extruded plastic pipe;
a handle threadably received by said threaded end of said coupling; and,
a cap attached to said second end of said extruded plastic pipe.

2. The device of claim 1 including a plurality of circular discs having centrally disposed apertures therethrough mounted onto said extruded plastic pipe.

3. The device of claim 1, said circular discs being filter elements.

4. The device of claim 3, said filter elements being of a disc-dam configuration.

5. The device of claim 1, said threaded end of said molded plastic coupling having male threads and said handle having female threads.

6. The device of claim 1, said cap being fixedly attached to said extruded plastic pipe.

7. The device of claim 1, said molded plastic coupling being fixedly attached to said extruded plastic pipe.

8. The device of claim 1, said extruded plastic pipe being PVC.

9. The device of claim 1, said molded coupling being PVC.

10. The device of claim 1, said handle including a grip portion and a bushing portion with a tube connecting said grip portion to said bushing portion, said bushing portion having mating threads for mating with said threaded end of said coupling.
